(19) United States
(12) Patent Application Publication
(10) Pub. No.: US 2007/0204984 A1
(43) Pub. Date: Sep. 6, 2007

(54) Coolant circuit and method of cooling a fuel cell stack

(75) Inventor: Uwe Limbeck, Kirchheim (DE)

Correspondence Address: CROWELL & MORING LLP;INTELLECTUAL PROPERTY GROUP, P.O. BOX 14300, WASHINGTON, DC, 20044-4300, US

(73) Assignee: NuCellSys GmbH, Kirchheim/Teck-Nabern (DE)

(21) Appl. No.: 11/702,078

(22) Filed: Feb. 5, 2007

(30) Foreign Application Priority Data
Feb. 6, 2006 (DE) 102006005176.9

(51) Int. Cl. B60H 3/00; B60H 1/00

(52) U.S. Cl. 165/202; 165/42

(57) ABSTRACT

A coolant circuit for cooling a fuel cell stack for a motor vehicle includes a heating device for raising the temperature of the coolant and a cooling device for lowering the temperature of the coolant. The cooling device and the heating device are fluidically connected in series in the coolant circuit. The cooling device is constructed as an external cooler for the vehicle.

### BACKGROUND AND SUMMARY OF THE INVENTION

This application claims the priority of German patent document10 2006 005 176.9, filed Feb. 6, 2006, the disclosure of which is expressly incorporated by reference herein.

The invention relates to a coolant circuit for cooling a fuel cell stack for a vehicle, which circuit includes a heating device for raising the temperature of the coolant and a cooling device for lowering the temperature of the coolant, with the cooling device and the heating device being fluidically connected or connectable in series in the coolant circuit.

Fuel cell stacks are used for generating electric energy, the current being generated in an electrochemical reaction of fuel and an oxidant, without mechanical and/or thermal intermediate processes. For an optimal yield of energy as well as for a long service life of the fuel cell stack, it is necessary to keep the operating temperature of the fuel stack within a defined desired value. For this purpose, fuel cell stacks normally have a coolant circuit by which controls the operating temperature.

Examples of coolant circuit operations of the above-mentioned type are disclosed in U.S. Pat. No. 6,454,180 B2. This document describes an air-conditioning device in a motor vehicle, in which the thermal control is coupled with a cooling-water circuit of a fuel cell stack. In some of the described embodiments, the coolant pump, an electric heating element and a heat exchanger for the interior of the motor vehicle are arranged in the flow direction starting from the fuel cell stack; the heat exchanger heats the interior by means of the heated coolant. For a further cooling, a second heat exchanger in the form of an external cooler is provided in the coolant circuit and is arranged parallel with the heating element.

It is an object of the present invention to provide a coolant circuit and a method of cooling a fuel cell stack for a vehicle which permit the controlling of the coolant temperature in a particularly simple and effective manner.

This and other objects and advantages are achieved by the coolant circuit according to the invention, which is suitable and/or constructed for operation by means of a coolant (preferably water or water/ethylene glycol mixtures, particularly de-ionized and/or demineralized water), and for cooling and/or tempering a fuel cell stack for a vehicle. The fuel cell stack preferably comprises a plurality of fuel cells which are used for generating electric energy by electrochemical processes. These may be arbitrary fuel cells, preferably of the PEM (polymer electrolyte membrane) construction.

In one embodiment of the invention, a heating device is arranged and/or constructed such that the coolant can flow through it in order to raise the temperature of the flowing-through coolant during the operation of the coolant circuit. On the other hand, a cooling device is provided for lowering the temperature of the coolant and, for this purpose, is also arranged and/or constructed such that the coolant can flow through it. The heating and/or cooling device is preferably implemented so that it can be controlled and/or regulated. In particular, the heating device is used for the feeding of heat (and therefore energy) into the coolant circuit, and the cooling device is used for the removal of heat (and energy from the coolant circuit.

The cooling device and the heating device are placed so that they can be and/or are successively (serially and/or sequentially), circuited. In particular, the cooling and heating devices are placed in a common coolant circuit branch which starts and ends at the fuel cell stack.

According to the invention, the cooling device is constructed as an external cooler for the vehicle, preferably arranged such that cooling air for cooling the external cooler is circulated outside the vehicle interior, and is guided past the vehicle interior. (In particular, it is not guided into the vehicle interior.) The external cooler is preferably constructed as the main cooler in the coolant circuit and has the greatest cooling capacity of the active and/or passive cooling devices integrated in the coolant circuit.

Applicants have found that, surprisingly, such an arrangement of an external cooler and a heating device improves the flow properties of the coolant in the coolant circuit.

In a preferred embodiment of the invention, the external cooler is arranged behind the heating device in the flow direction of the coolant, further improving the flow properties.

In a particularly preferred embodiment of the invention, the heating device is connected behind a coolant pump in the flow direction of the coolant. Thus, the coolant pump, the heating device and the external cooler are connected or are connectable in the flow direction of the coolant, particularly in the above-mentioned sequence, behind one another. This construction was found to be an almost optimal solution for the flow properties of the coolant within the coolant circuit. Preferably, exactly one coolant pump is provided in the coolant circuit.

In another embodiment, the coolant circuit is constructed such that the coolant flow through the external cooler can be controlled independently of the coolant flow through the heating device. In particular, a controlled change of the coolant flow through the external cooler can be implemented independently and/or uncoupled from the coolant flow through the heating device.

This embodiment is based on the idea that, although the existing concepts for coolant circuits permit the adjustment of a defined desired value for the coolant temperature, they are not yet optimally designed for deviation control of temperature fluctuations which may arise due to the interaction of the heating device and the cooling device. In contrast to the known state of the art, control of the coolant temperature is regulated according to the invention by way of the flow-through of the coolant, with the flow through the cooling device being adjustable independently of the flow through the heating device. The total flow-through quantity in the coolant circuit preferably remains constant. This embodiment according to the invention thereby permits simple, effective and very precise control of the coolant temperature.

In a very simple embodiment of the coolant circuit, the coolant flow through the heating device can be controlled in a binary manner; that is, it can be switched only between a maximal flow and a minimal flow. In preferred embodiments, the coolant flow-through can be controlled in a stepped or continuous manner, with intermediate values between a minimal and a maximal flow-through.

In a preferred further embodiment of the invention, a bypass pipe is arranged and/or connected in the coolant circuit parallel to the external cooler. The bypass pipe is preferably constructed such that the coolant can be guided either through the external cooler and/or through the bypass pipe.

A fluidic control element is preferably provided in the coolant circuit, so that the ratio of the coolant flow-through between the external cooler and the bypass pipe is controllable. The control element is therefore constructed as a coolant distributor between the bypass pipe and the external cooler.

In a further preferred embodiment, the control element comprises a valve (particularly a disk valve, a slanted-seat valve, a rolling diaphragm valve or a snap valve), and has a mechanically operable and/or automatically operated.

The control element, particularly the valve, is preferably arranged behind the bypass pipe and/or behind the external cooler in the flow direction of the coolant. In other words, by means of the control element, the ratio between the coolant flowing through the bypass pipe and the coolant flowing through the external cooler is controlled when the two coolant flows are combined. In contrast, in an alternative embodiment, the control element is arranged in front of the bypass pipe and/or the external cooler in the flow direction of the coolant, so that the distribution of the two coolant flows is controlled directly. In particular, the control element is constructed as a 3/2-way valve or 3-way valve, particularly having two inlets and one outlet or two outlets and one inlet.

The heating device and/or the external cooler can expediently be operated by outside energy, with the heating device and/or the external cooler being constructed particularly as active devices. Particularly preferably, the heating device is constructed as an electric heater and/or the external cooler is constructed as a heat exchanger or radiator, particularly as an air cooler or air radiator, optionally with cooling ventilators.

This embodiment of the invention has the additional advantage that the energy demand for the temperature control is reduced in comparison with the conventional coolant circuits, as substantiated by the fact that conventional coolant circuits implement the temperature control only by using outside energy (that is, by active cooling or active heating). In contrast, the invention achieves or at least promotes temperature control by changing the mixture ratio of cooled and uncooled coolant.

Preferably a sensor element for detecting the input temperature of the coolant into the fuel cell stack and a control device for controlling the coolant flow through the external cooler, particularly for controlling the control element, are constructed in the coolant circuit for controlling the coolant temperature. In this construction, a regulating or control circuit is preferably implemented, in which the input temperature into the fuel cell stack is provided as the measured quantity, a particular load-dependent coolant temperature is provided as the desired value, and the coolant flow through the external cooler is provided as the control variable. The control device is preferably constructed in addition to the controlling and/or regulating of the heating device and/or of the external cooler and/or of the ventilators of the external cooler and/or of the coolant pump.

In a further embodiment, the control device is constructed in addition to the control and/or regulation of additional fluidic connections connected parallel to the bypass pipe and/or to the external cooler. The latter connections comprise additional cooling devices, such as interior heaters or fuel cell air cooler and/or filtering elements and/or additional valves.

The invention also provides a method of tempering a fuel cell stack, preferably using the coolant circuit described above. For this purpose, an external cooler for lowering the temperature of the coolant and a heating device for raising the temperature of the coolant can be and/or are connected in series in a or the coolant circuit.

Other objects, advantages and novel features of the present invention will become apparent from the following detailed description of the invention when considered in conjunction with the accompanying drawings.

### BRIEF DESCRIPTION OF THE DRAWINGS

The single Figure is a view for a coolant circuit according to the invention, illustrating the flow.

### DETAILED DESCRIPTION OF THE DRAWINGS

The Figure illustrates a coolant circuit 1 for a fuel cell stack 2 which is constructed of several fuel cells, preferably in a PEM construction. Such a coolant circuit is used, for example, vehicles operated by fuel cell technology. The fuel cell stack 2 has a coolant inlet 3 and a coolant outlet 4 to which the coolant circuit 1 is connected. Thus, the coolant (for example, water) can flow out of the fuel cell stack 2 by way of the coolant outlet 4 into the coolant circuit 1, circulates through the latter and, by way of the coolant inlet 3, enters the fuel cell stack 1 again.

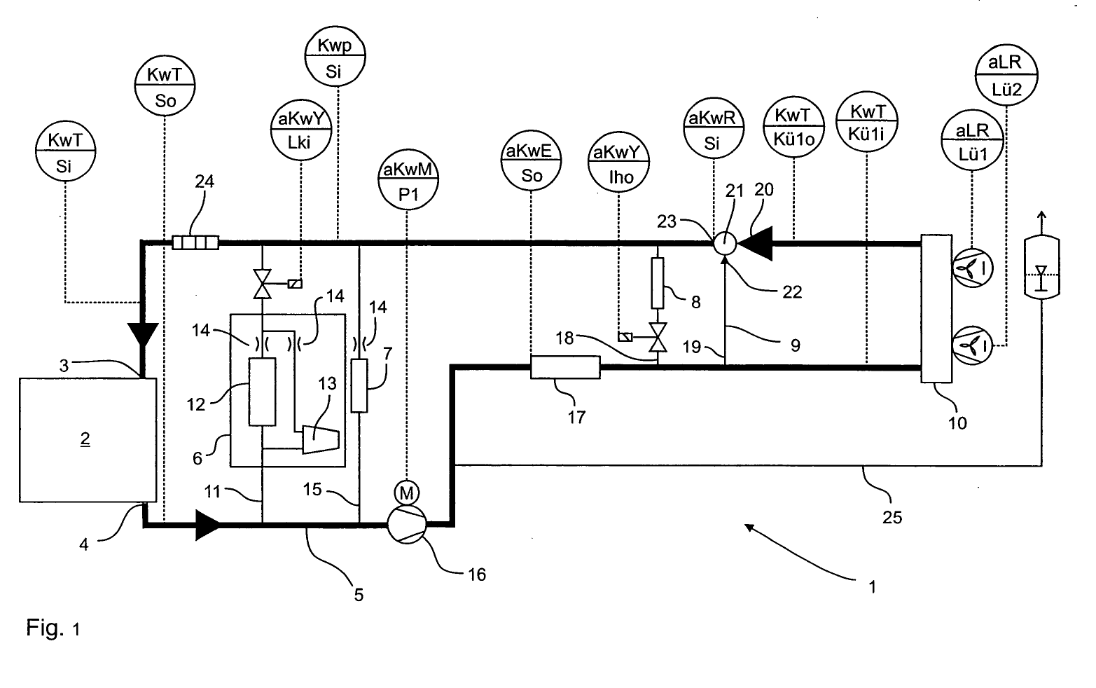

The architecture of the coolant circuit 1 is a simple ring structure, formed by a combination of pipe sections, providing a maximal flow path for the coolant without any reversal of the flow direction. In FIG. 1, the ring 5 is indicated by thicker lines.

A compression device 6, an ion exchanger device 7, an interior heating device 8 and a bypass pipe 9 are provided as intermediate connections in the ring 5. The above-mentioned intermediate connections are fluidically arranged parallel to one another in the ring 5, and placed parallel to a heat exchanger 10 that is serially integrated in the ring 5 as well as to the fuel cell stack 2.

The precise construction of the coolant circuit will be explained in the following starting from the fuel cell stack 2 in the flow direction of the coolant.

From the coolant outlet 4, the coolant is guided into the ring 5. Fluidically directly behind the coolant outlet, a measuring device KwT-So (that is, cooling water temperature—stack out) is arranged which measures the temperature of the coolant flowing out of the fuel cell stack 2 and has a measuring range of from 40° C. to 130°

Behind the measuring device KwT-So, a first intermediate connection branches off from the ring 5 by way of a first junction 11, the first junction 11 forming an inlet for the compression device 6. In the compression device 6, the coolant flow branched off the ring 5 is guided via another branching partly into a fuel cell air cooler 12 and partly into an air compressor 13. In the air compressor 13, the air taken in from the outside, which is fed as an oxidant to the fuel cell stack, is compressed (for example, as a function of the load), the temperature of the air being thereby increased. To reduce the temperature, on the one hand, mechanical components which come in thermal contact with the air to be compressed, particularly the rotors, are cooled by the coolant in the air compressor 13 which is constructed, for example, as a rotary screw compressor. For a further reduction of the temperature, the compressed and precooled air is guided through a fuel cell air cooler 12, which is also actively cooled by the coolant.

A respective throttle 14 is arranged behind each of the fuel cell air cooler 12 and the air compressor 13. These throttles 14 can statically or dynamically adjust the coolant flow through the fuel cell air cooler 12 and the air compressor 13 respectively can be statically or dynamically adjusted. Behind the throttles 14, the two partial flows are combined again and are guided by way of a first valve aKwY-Lki (actuator cooling water valve-air cooling in) into the ring 5 in the area of the inlet into the fuel cell stack 2. The first valve aKwY-Lki has a valve gear so that the flow of the coolant through the first connection pipe and thereby through the compression device 6 can be adjusted and/or controlled.

Behind the first junction 11, the remaining coolant flow is guided in the ring 5 to a second junction 15 which again couples a portion of the coolant flow out of the ring 5 and feeds it to the ion exchanger device 7. The ion exchanger device 7 is used particularly for the removal of interfering ions in the coolant and, in addition, particularly for demineralizing the coolant. Behind the ion exchanger device 7, the coolant is returned by way of another throttle 14, for dynamic or static adjustment of the flow-through into the ring 5 in the flow direction in front of the coolant return out of the compression device 6.

Starting from the second junction 15 and continuing to follow the flow direction of the coolant in the ring 5, a coolant pump 16 is arranged which is driven by a motor M controlled by a control device aKwM-P1 (actuator cooling water motor—P1). The coolant pump 16 moves the coolant through the coolant circuit 1.

In the ring 5, a heating device 17 is arranged in the flow direction as a next element, particularly directly behind the coolant pump 16, serially in the ring 5, to increase the temperature of the coolant. The arrangement of the heating device 17 in the flow direction of the coolant behind the coolant pump 16, particularly directly behind the coolant pump 16, has also been successful in the case of other designs of coolant circuits. The heating device 17 is controlled by way of a control device aKwE-So (actuator cooling water energy—stack out).

In the further course of the ring 5, a third junction 18 is provided downstream, which branch 18 guides a partial flow of the coolant by way of a second valve aKwy-Iho (actuator cooling water valve—interior heating device out) to the interior heating device 8. The second valve aKwY-Iho also has a valve drive so that the flow of the coolant through the interior heating device 9 can be controlled, for example, statically or dynamically. The interior heating device 8 is constructed as a heat exchanger and is used for the heating of the occupant compartment. Behind the interior heating device 8, the coolant flow is returned upstream directly in front of the return flow from the ion exchanger device 7 into the ring 5. The first valve aKwY-Lki as well as the second valve aKwY-Iho are open in the normal operation.

In the ring 5, a fourth junction 19 is arranged in the flow direction behind the third junction, which fourth junction 19 guides a partial flow into the bypass pipe 9. The not branched-off residual flow of the coolant arrives in the heat exchanger 10, is cooled there and, following the ring 5, is guided into a first inlet 20 of the 3-way valve 21, to whose second inlet 22 the bypass pipe 29 is connected. The outlet 23 of the 3-way valve guides the coolant by way of the ring 5 back to the fuel cell stack 2.

One measuring device KwT-Kuli (cooling water temperature cooler in) and KwT-Kulo (cooling water temperature cooler out) respectively is arranged in the flow direction in front of and behind the heat exchanger 10 for measuring the input and output temperature of the coolant. The heat exchanger 10 is optionally cooled by ventilators aLR-Lü1 and aLR-Lü2 (actuator ventilating control—ventilator 1 and 2 respectively).

The 3-way valve 21 has the purpose of mixing uncooled coolant from the bypass pipe 9 with cooled coolant from the radiator 10. Depending on the mixing ratio of the two partial flows, it is possible to obtain a temperature between the temperature of the cooled and of the uncooled coolant, and feed the coolant to the fuel cell stack 2 by way of the outlet 23. The change of the mixing ratio can be controlled at low energy expenditures and highly dynamically by controlling the 3-way valve by means of a control device aKwR-Si (actuator cooling water regulating—stack in).

The 3-way valve 21 is controlled based on a defined desired temperature for the coolant at the coolant inlet 4 of the fuel cell stack 2. The control device readjusts or automatically controls the coolant temperature on the basis of the desired temperature by controlling the 3-way valve 21. In more complex control devices, the measured quantities of several or of all measuring devices illustrated in FIG. 1 are taken into account as additional input quantities. It is optionally provided that, in addition to the 3-way valve 21, the control devices controls and/or regulates several or all of the actuators in FIG. 1, particularly the ventilators.

As additional components, the coolant circuit has a filter directly in front of the coolant inlet 3 and an excess pressure device 25 behind the coolant pump 16, which excess pressure device 25 opens, for example, starting at an excess pressure of 0.8 bar.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### List of Reference Numbers

1 Coolant circuit
2 fuel cell stack
3 coolant inlet
4 coolant outlet
5 ring
6 compression device
7 ion exchanger device
8 interior heating device
9 bypass pipe
10 heat exchanger
11 first junction
12 fuel cell air cooler
13 compressor
14 throttle
15 second junction
16 coolant pump
17 heating device
18 third junction
19 fourth junction
20 first inlet of 3-way valve
21 3-way valve
22 second inlet of 3-way valve
23 outlet of 3-way valve
24 filter
25 excess pressure device

What is claimed is:

1. A coolant circuit for cooling a fuel cell stack in a vehicle, comprising:
a heating device for raising the temperature of the coolant; and
a cooling device for lowering the temperature of the coolant; wherein, the cooling device and the heating device are fluidically connected or connectable in series in the coolant circuit; and
the cooling device comprises an external cooler for the vehicle.

2. The coolant circuit according to claim 1, wherein the external cooler is connected behind the heating device in a flow direction of the coolant.

3. The coolant circuit according to claim 1, wherein the heating device is connected behind a coolant pump in a flow direction of the coolant.

4. The coolant circuit according to claim 1, wherein the coolant flow through the external cooler can be controlled independently of the coolant flow through the heating device.

5. The coolant circuit according to claim 1, wherein the coolant flow through the external cooler can be controlled in steps or continuously.

6. The coolant circuit according to claim 1, wherein a bypass pipe is arranged in the coolant circuit parallel to the external cooler.

7. The coolant circuit according to claim 6, wherein a ratio of coolant flow through the external cooler and through the bypass pipe can be controlled by a fluidic control element.

8. The coolant circuit according to claim 7, wherein the control element comprises a valve arranged in a location that is behind at least one of the bypass pipe and the external cooler in a flow direction of the coolant.

9. The coolant circuit according to claim 1, werein at least one of the heating device and the external cooler is operated using outside energy or is constructed as an active device.

10. The coolant circuit according to claim 1, wherein at least one of the following is true:
the heating device comprises an electric heater; and
the external cooler is constructed as a heat exchanger.

11. The coolant circuit according to claim 10, wherein the heat exchanger has cooling ventilators.

12. The coolant circuit according to claim 1, further comprising:
a sensor for detecting input temperature of the coolant into the fuel cell stack; and
a control device for controlling the input temperature by changing the coolant quantity flowing through the external cooler.

13. A method of tempering a fuel cell stack having a coolant circuit; said method comprising:
lowering the temperature of a coolant via an external cooler; and
raising the temperature of the coolant via a heating device;
wherein the heating device and the cooler are connected in series in the coolant circuit.
